(19) United States
(12) Patent Application Publication
(10) Pub. No.: US 2023/0365070 A1
(43) Pub. Date: Nov. 16, 2023

(54) TRAILER ATTACHMENT

(71) Applicant: Joseph A. Wilkinson, JR., Leonardtown, MD (US)

(72) Inventor: Joseph A. Wilkinson, JR., Leonardtown, MD (US)

(21) Appl. No.: 18/196,287

(22) Filed: May 11, 2023

Related U.S. Application Data
(60) Provisional application No. 63/340,615, filed on May 11, 2022.

(51) Int. Cl. B60R 11/00

(52) U.S. Cl. CPC B60R 11/00; B60R 2011/004

(57) ABSTRACT

A trailer attachment for a trailer that is mountable to a fifth wheel hitch, the trailer attachment including a first cylindrical collar adapted to fit around a king pin of the trailer and a second cylindrical collar spaced at a distance from the first cylindrical collar, the second cylindrical collar adapted to accommodate a flagpole. A frame extends between the first cylindrical collar and the second cylindrical collar and a stop is positioned on the frame, the stop configured to abut a portion of the trailer.

### CROSS-REFERENCE TO RELATED APPLICATION

This application claims the benefit of U.S. Provisional Application, Serial No. 63/340,615, filed on 11 May 2022. The co-pending provisional application is hereby incorporated by reference herein in its entirety and is made a part hereof, including but not limited to those portions which specifically appear hereinafter.

### BACKGROUND OF THE INVENTION

### Field of the Invention

This invention relates generally to a trailer attachment and, more particularly, to a trailer attachment for the display of a flag or similar item.

### Description of Prior Art

Vehicles utilize trailer hitches and related attachment devices for towing trailers, RVs and/or similar towable items. Different vehicles of varying towing capacities as well as varying types and strengths of trailer hitches may be used depending on various factors of the towed load, including weight, size, etc.

One such trailer hitch is a fifth wheel trailer hitch customarily attached to a trailer/RV/camper. The fifth wheel trailer hitch protrudes from a position along a camper, and attaches to a corresponding hitch assembly on a vehicle that will tow the camper. The fifth wheel trailer hitch assembly on the trailer side includes a king pin that facilitates the attachment of the fifth wheel trailer hitch to the vehicle.

The subject invention provides a trailer attachment apparatus that may be included with the king pin/fifth wheel trailer hitch assembly to provide an additional functionality to the trailer hitch to be able to display a flagpole or similar item.

### SUMMARY OF THE INVENTION

The invention generally relates to a trailer attachment device that can be attached to a king pin of a trailer hitch.

The general object of the invention can be attained, at least in part, through a trailer attachment apparatus that includes a first cylindrical collar. The first cylindrical collar is sized and shaped to fit around a king pin of a trailer, such as an RV. The first cylindrical collar includes an aperture through a side wall of the first cylindrical collar. The aperture is configured to receive a fastener such as a thumb screw to maintain a connection between the first collar and the king pin.

The trailer attachment apparatus preferably further includes a second cylindrical collar, preferably with a greater diameter than the first cylindrical collar. A frame comprising at least two support bars extend from the first cylindrical collar to the second cylindrical collar. The trailer attachment apparatus may further include a stop positioned at a point between the first cylindrical collar and the second cylindrical collar. The stop is affixed along a top of the at least two support bars, arranged perpendicular to the frame and support bars.

Other objects and advantages will be apparent to those skilled in the art from the following detailed description taken in conjunction with the appended claims and drawings.

### BRIEF DESCRIPTION OF THE DRAWINGS

FIG. 1 shows a perspective view of a trailer attachment apparatus according to one embodiment;

FIG. 2 shows a top view of the trailer attachment apparatus according to the embodiment shown in FIG. 1;

FIG. 3 shows a front view of the trailer attachment apparatus according to the embodiment shown in FIG. 1;

FIG. 4 shows a side view of the trailer attachment apparatus according to the embodiment shown in FIG. 1;

FIG. 5 shows a side view of a trailer attachment apparatus according to another embodiment;

FIG. 6 shows a top view of the trailer attachment according to the embodiment shown in FIG. 5;

FIG. 7 shows a top view of the trailer attachment according to the embodiment shown in FIG. 5;

FIG. 8 shows a side view of an adjustable stop according to one embodiment;

FIG. 9 shows a bottom view of the adjustable stop according to the embodiment shown in FIG. 8;

FIG. 10 shows a side view of the trailer attachment shown in FIG. 5 in an assembled condition on a trailer; and

FIG. 11 shows a perspective view of the king pin.

### DETAILED DESCRIPTION OF THE INVENTION

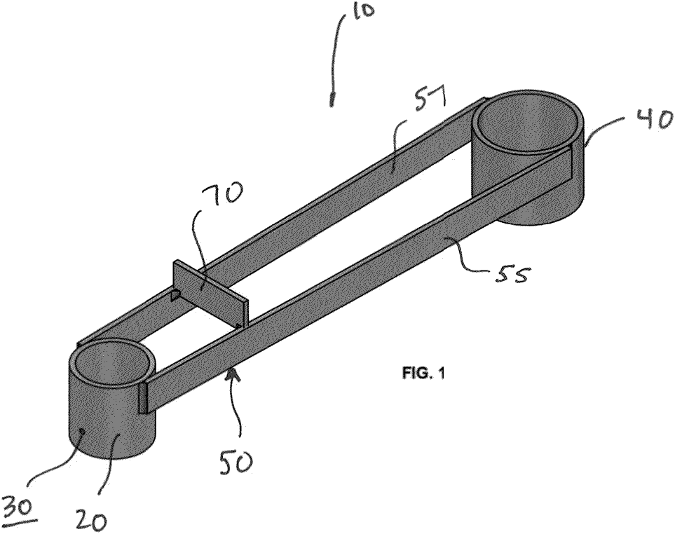

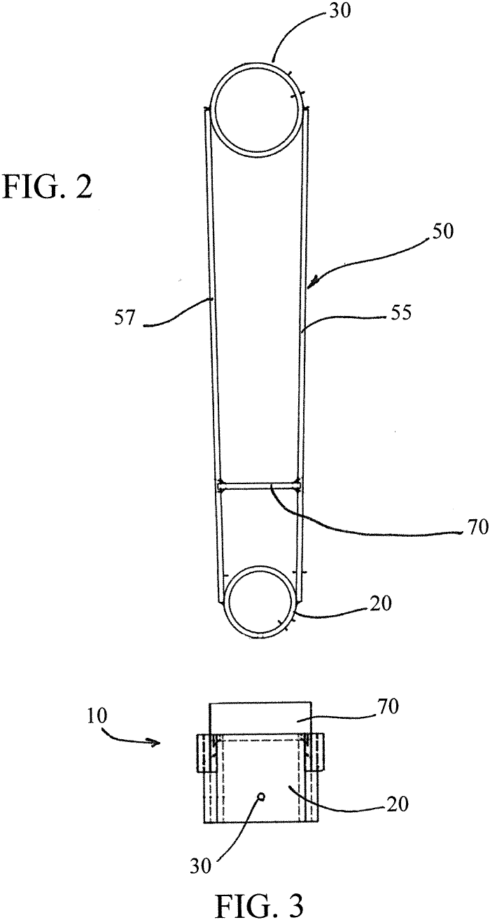

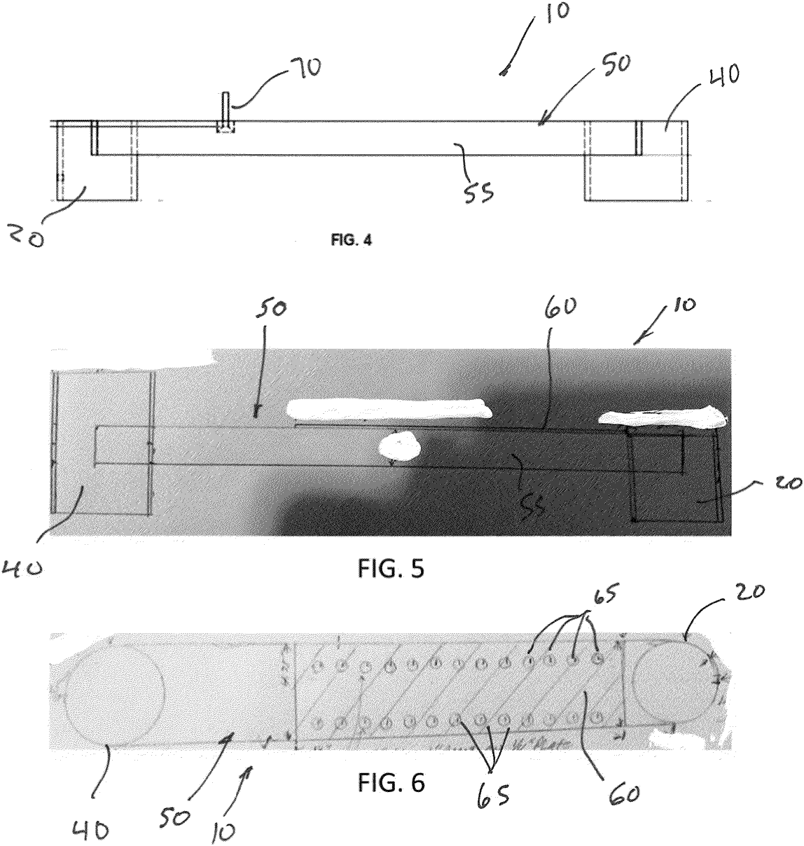

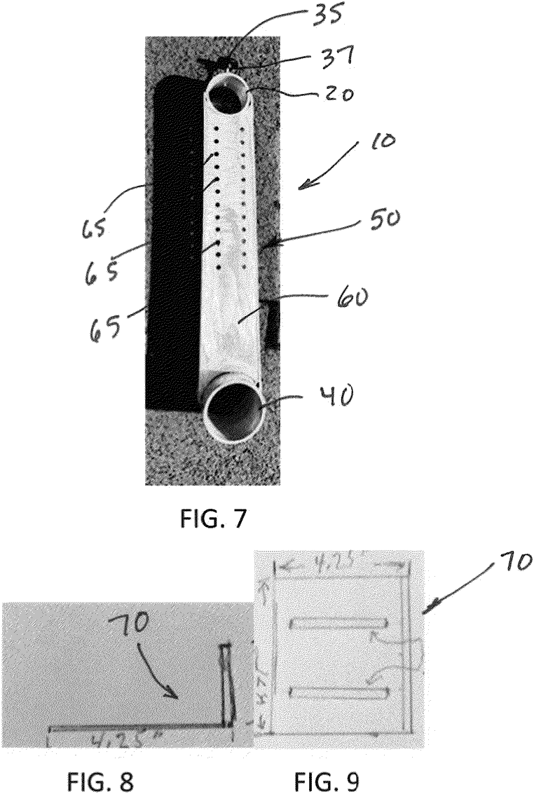

The present invention provides a trailer attachment apparatus. FIGS. 1-11 show various embodiments of a trailer attachment apparatus for use with a conventional fifth wheel hitch and king pin. Fifth wheel hitches are typically bed mounted hitches in pick-up trucks, flatbeds, and similar high tow capacity commercial and consumer vehicles. Trailers for use with such fifth wheel hitches typically include recreational vehicles, trailers, and other large towed wheeled trailers and include a downward directed king pin 100 that engages with the hitch, such as shown in FIG. 11.

According to a preferred embodiment, the trailer attachment 10 includes a first cylindrical collar 20 and a second cylindrical collar 40. The first cylindrical collar 20 is preferably sized and shaped so that the first cylindrical collar 20 can fit around or otherwise engage with a king pin 100. As described above, the king pin 100 is a large pin usually including a circular groove in the body that is commonly used with fifth wheel hitches. The king pin 100 centers and attaches such a trailer hitch to a vehicle. The first collar 20 is preferably sized and shaped for various types of king pins as well as other types of trailer hitch designs. As used herein “cylindrical” means circular or generally circular however the first and second collars 20, 40 may be polygonal, oval or otherwise formed provided each are capable of engaging with their respective components.

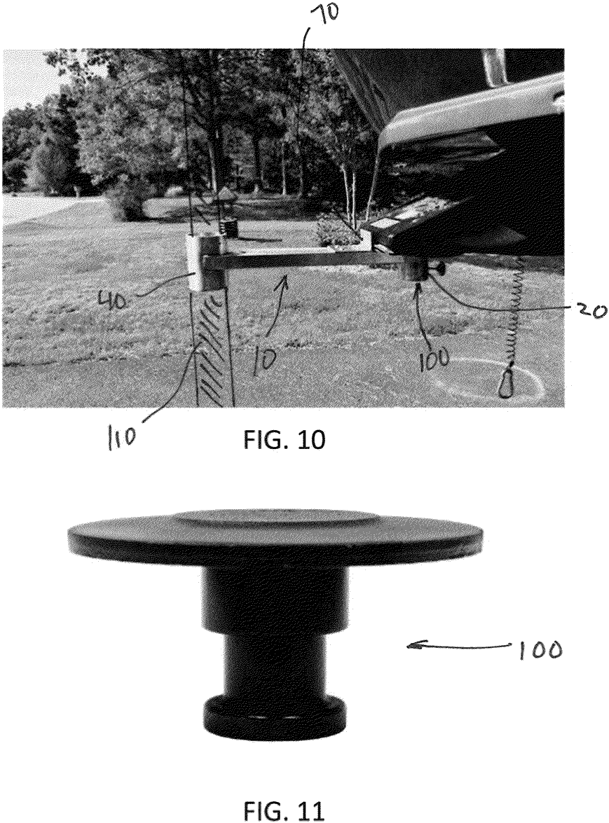

As shown in FIGS. 1-9, the trailer attachment 10 for a trailer that is mountable to a fifth wheel hitch includes the first cylindrical collar 20 adapted to fit around the king pin 100 and an oppositely positioned second cylindrical collar 40. The second collar 40 is preferably spaced at a distance from the first collar 20 and is preferably sized to accommodate a flagpole 110 so as to enable a user to display a flag from the front of an RV or trailer, as best shown in FIG. 10. In a preferred embodiment, the second collar 40 includes a larger diameter than the first collar 20.

A frame 50 preferably extends between the first cylindrical collar 20 and the second cylindrical collar 40. As shown in FIGS. 1-4, the frame 50 may comprise two support bars 55, 57 extending between the first collar 20 and the second collar 40. Alternatively, or in addition, as shown in FIGS. 5-7, the frame 10 may further comprise a plate 60 extending at least partially between the two support bars 55, 57 and/or between the first collar 20 and the second collar 40.

A stop 70 is preferably positioned at a point between the first collar 20 and the second collar 40. The stop 70 is preferably affixed along a top of the frame 50 and preferably extends upwardly from the frame 50. In practice, and once the trailer apparatus is properly affixed, the stop 70 is preferably configured to abut a portion of the trailer, as best shown in FIG. 10. In this manner, the stop 70 prevents or minimizes movement of the trailer attachment 10 when a flag is emplaced in the second collar 40 thereby reducing potential for swiveling or detaching in the event of high winds.

According to one embodiment, an aperture is formed through a side wall of the first collar 20 and is configured to receive a fastener 35. The fastener 35 may comprise a thumb screw 37, biased pin, or other component to ensure a fast connection between the first collar 20 and the king pin 100. Once the first collar 20 is inserted over the king pin 100, the fastener 35 is engaged or inserted and further may be tightened through the aperture 30 to engage with the king pin 100 and affix the trailer attachment 10 to the king pin 100. In one embodiment, the first collar 20 may be lockable to the king pin 100 of the trailer using a keyed latch or padlock arrangement.

According to one embodiment shown in FIGS. 5-9, the trailer attachment 10 may include a stop 70 that is repositionable along the frame 50. In one embodiment, the frame 50 and specifically the plate 60 may include a plurality of mount holes 65 and the stop 70 is configured to mount on two or more of the plurality of mount holes 65.

In one embodiment the second collar 40 may be longer than the first collar 20. This permits the second collar 40 to coextend for a longer segment of the flagpole to ensure maintenance of the flagpole within the trailer attachment 10. The second collar 40 may be adjusted in size and shape for various types of flag poles as well as other display items.

Both the first and second collars 20, 40 may include a variety of lengths, approximately 2-10 inches, and more preferably 4-6 inches. Both the first and second collars 20, 40 may include the same length, or different lengths depending on need.

The frame 50 and/or support bars 55, 57 may be sized to allow adequate space between the king pin 100 location where the first collar 20 is applied and the second collar 40 so that a flagpole and flag may be adequately displayed (vertically) through the second collar 40 while the trailer attachment 10 is attached to the trailer (such as an RV).

The trailer attachment 10 may be welded steel, molded plastic or otherwise formed to provide a rigid attachment for the desired application. Other materials and attachment means may be used depending on need for size, strength, and adaptability of the trailer attachment apparatus.

The invention illustratively disclosed herein suitably may be practiced in the absence of any element, part, step, component, or ingredient which is not specifically disclosed herein.

While in the foregoing detailed description this invention has been described in relation to certain preferred embodiments thereof, and many details have been set forth for purposes of illustration, it will be apparent to those skilled in the art that the invention is susceptible to additional embodiments and that certain of the details described herein can be varied considerably without departing from the basic principles of the invention.

What is claimed is:

1. A trailer attachment for a trailer that is mountable to a fifth wheel hitch, the trailer attachment comprising:
a first cylindrical collar adapted to fit around a king pin;
an aperture through a side wall of the first cylindrical collar wherein the aperture is configured to receive a fastener;
a second cylindrical collar spaced at a distance from the first cylindrical collar;
a frame extending from the first cylindrical collar to the second cylindrical collar; and
a stop positioned at a point between the first cylindrical collar and the second cylindrical collar, wherein the stop is affixed along a top of the frame, the stop configured to abut a portion of the trailer.

2. The trailer attachment of claim 1 wherein the frame comprises two support bars extending from the first collar to the second collar.

3. The trailer attachment of claim 2 wherein the frame further comprises a plate extending between the two support bars.

4. The trailer attachment of claim 1 wherein the second collar has a larger diameter than the first collar.

5. The trailer attachment of claim 1 wherein the stop is repositionable along the frame.

6. The trailer attachment of claim 5 wherein the frame includes a plurality of mount holes and the stop is configured to mount on two or more of the plurality of mount holes.

7. The trailer attachment of claim 1 wherein the second collar is adapted to accommodate a flagpole.

8. The trailer attachment of claim 1 wherein the stop extends upward from the frame.

9. The trailer attachment of claim 1 wherein the second collar is longer than the first collar.

10. A trailer attachment for a trailer that is mountable to a fifth wheel hitch, the trailer attachment comprising:
a first cylindrical collar adapted to fit around a king pin of the trailer;
a second cylindrical collar spaced at a distance from the first cylindrical collar, the second cylindrical collar adapted to accommodate a flagpole;
a frame extending from the first cylindrical collar to the second cylindrical collar; and
a stop positioned at a point between the first cylindrical collar and the second cylindrical collar, wherein the stop is adjustably affixed along a top of the frame, the stop configured to abut a portion of the trailer.

11. The trailer attachment of claim 10 wherein the first collar includes an aperture through a side wall, wherein the aperture is configured to receive a fastener.

12. The trailer attachment of claim 11 wherein the fastener comprises a thumb screw.

13. The trailer attachment of claim 10 wherein the frame includes a plurality of mount holes to accommodate adjustability of the stop.

14. The trailer attachment of claim 10 wherein the first collar is lockable to the king pin of the trailer.

15. The trailer attachment of claim 10 wherein the first collar includes a biased pin for engaging with the king pin of the trailer.
